(19) United States
(12) Patent Application Publication
(10) Pub. No.: US 2024/0346392 A1
(43) Pub. Date: Oct. 17, 2024

(54) METHODS AND SYSTEMS FOR AGRICULTURAL NUTRIENT MANAGEMENT

(71) Applicant: Dark Horse Ag Ventures Ltd., Saskatoon (CA)

(72) Inventors: Tyler LEFLEY, Saskatoon (CA); Garrett FRASER, Rocky View County (CA); Alexei MELNITCHOUCK, Calgary (CA); Elston SOLBERG, Edmonton (CA)

(21) Appl. No.: 18/134,119

(22) Filed: Apr. 13, 2023

(51) Int. Cl. G06Q 10/04; G06Q 10/0631

(52) U.S. Cl. CPC G06Q 10/04; G06Q 10/06313

(57) ABSTRACT

Computer-implemented methods and systems for nutrient management. The method comprises obtaining a plurality of crop yield datasets for a field and a plurality of historic crop uptake and removal rates for the field. The crop yield datasets contain a plurality of point yields corresponding to a plurality of locations in the field and corresponding to a plurality of seasons. The historic crop uptake and removal rates for the field correspond to the plurality of locations in the field. A delta value of at least one soil nutrient is determined based on the obtained historic crop yield datasets and the obtained crop uptake and removal rates. A productivity map for the field is generated based on the level of the at least one soil nutrient.

### TECHNICAL FIELD

The disclosed exemplary embodiments relate to methods and systems for agricultural nutrient management.

### BACKGROUND

One aspect of farm management is the use of yield data from previous crops to estimate future yields for a particular field. Conventionally, agronomists may estimate future yields based on point-in-time snapshots of field, such as satellite images. Alternatively, farmers may maintain coarse, field-level yield data. However, for any given field, there may be significant yield variability within the field itself. This is due to a wide variety of factors, such as soil quality, ground water, irrigation methods, fertilization methods, proximity to field boundaries, pests, and many more.

### SUMMARY

The following summary is intended to introduce the reader to various aspects of the detailed description, but not to define or delimit any invention.

In at least one broad aspect, there is provided a method for nutrient management for a field, the method comprising: obtaining a plurality of crop yield datasets for the field, each of the crop yield datasets containing a plurality of point yields corresponding to a plurality of locations in the field and corresponding to a plurality of seasons; obtaining a plurality of historic crop uptake and removal rates for the field, each of the plurality of historical crop uptake and removal rates corresponding to the plurality of locations in the field; determining a delta of at least one soil nutrient based on the obtained historic crop yield datasets for each of the plurality of locations in the field and the obtained crop uptake and removal rates; and generating a productivity map for the field based on the delta of the at least one soil nutrient.

In some cases, the at least one soil nutrient may be at least one of nitrogen, phosphorous, potassium and sulfur.

In some cases, the method further comprises determining a previously grown crop in each of the plurality of locations in the field.

In some cases, the method further comprises extracting nutrient information from a reference table.

In some cases, each of the plurality of historic crop uptake and removal rates may be determined based on a corresponding crop yield dataset, a corresponding location in the field, and an amount of nitrogen released.

In some cases, the amount of nitrogen released may be based on an amount of nitrogen applied in a season of the plurality of seasons and an amount of nitrogen removed by a crop, the amount of nitrogen removed by the crop extracted from the reference table.

In some cases, the determining the delta of the at least one soil nutrient further comprises dividing each of the plurality of crop uptake and removal rates by the nutrient information extracted from the reference table.

In some cases, the method further comprises determining an average efficiency for the at least one soil nutrient based on the delta for the at least one soil nutrient for the plurality of seasons.

In some cases, the plurality of locations in the field may be determined based on a grid, point, or polygon pattern, and wherein the grid and point pattern are based on latitude and longitude.

In some cases, the method further comprises providing a recommendation of an amount of the at least one soil nutrient to apply to each of the plurality of locations in the field.

In some cases, the method further comprises applying the at least one soil nutrient based on the productivity map. In some cases, the applying comprises controlling a distributor to apply the at least one soil nutrient.

In another broad aspect, there is provided a system for nutrient management, the system comprising: a memory storing at least one seasonal yield dataset for a field, containing a plurality of point yields corresponding to a plurality of locations in a field; and a processor, the processor configured to carry out any of the methods described herein.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of an exemplary system for nutrient management in accordance with at least some embodiments;

FIG. 2 is a block diagram of a computer in accordance with at least some embodiments;

FIG. 3 is a flowchart diagram of an exemplary method for nutrient management for execution by the system of FIG. 1;

FIG. 4 is a flowchart diagram of additional steps of the exemplary method of FIG. 3; and

FIG. 5 is a diagram of a productivity map generated by the system of FIG. 1.

### DETAILED DESCRIPTION

Estimation of yields is used not only to estimate output for a given crop. In particular, yield estimation can be used to determine the amount of seed and fertilizer that should be applied to obtain an achievable and desired target yield rate for a field. However, given that a yield varies from point to point even within a field, the application of fertilizer can be optimized to apply more densely in portions of a field—also known as zones—that consistently show high yield and, conversely, more sparsely in other zones that consistently show low yield.

Estimation of nutrient content in fields is another important aspect of farm management, which is dependent on a number of factors including, but not limited to, the application of nutrients such as nitrogen, phosphorus, potassium, and sulfur, and the type of crop or crops grown in the field, such as wheat (e.g. Canada Prairie Spring Wheat), canola, barley and similar. Depending on the nutrients applied and the crops grown, which may differ from zone to zone in the field, the depletion of nutrients in the field varies. As the nutrient content in a field impacts the crop yield, it may be desirable to estimate the levels of nutrients, and therefore inform those responsible for field management as to the required nutrient application for a favourable crop yield.

The described embodiments provide for reliable estimation of granular nutrient content for any field, based on historical, point-to-point data.

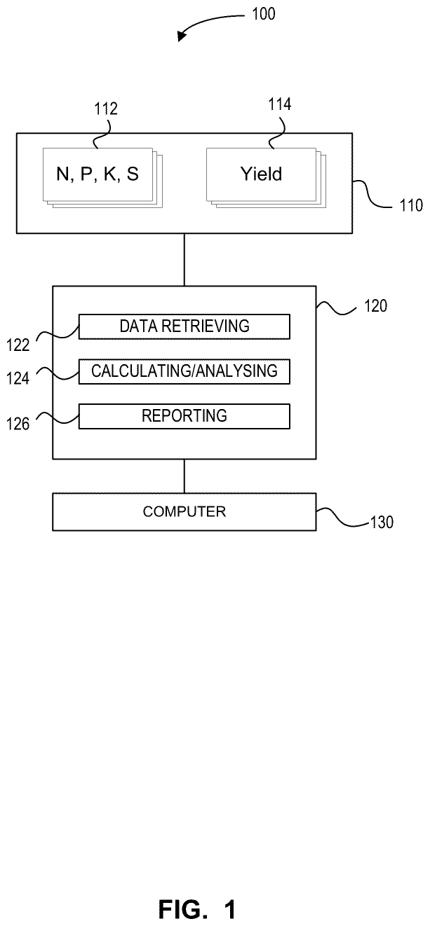

Referring now to FIG. 1, there is illustrated a schematic block diagram of a nutrient management system in accordance with at least some embodiments.

Example system 100 for nutrient management includes a database 110, a server 120, and an end node computer 130. The database contains datasets on soil nutrient information 112 and crop yield information 114. The soil nutrient information 112 includes crop uptake and removal rates of nutrients applied to the soil in a field, pertaining to nutrients such as nitrogen, phosphorus, potassium, and sulfur historically applied to the field. The field is divided into a plurality of different zones, for example at a size of 1 foot by 1 foot or larger, providing granular information on crop uptake and removal rates of nutrients applied in the field. Each zone may be identified by a grid reference or grid point, latitude and longitude, or a polygon pattern. The crop yield information 114 includes the crop yield and the type of crop or crops grown in each zone in the field. Both the soil nutrient information 112 and the crop yield information 114 may correspond to several seasons or years. This provides information on yield trends and uptake/removal trends over the period of time for which there is data.

The server 120 may include a variety of different modules including a data retrieving module 122, a calculating or analysing module 124, and a reporting module 126. The retrieving module 122 is configured to extract information for the desired period of time input by a user, which at a minimum may be one previous season, or two sets of crop harvest data. The retrieving module 122 then extracts the soil nutrient information 112 and the crop yield information 114 from the database 120 for the desired period of time.

The calculating module 124 analyses the extracted soil nutrient information 112 and crop yield information 114 and determines a delta (A) value for each nutrient (e.g. nitrogen, phosphorus, potassium, and sulfur). The reporting module 126 generates a productivity map 500 for the field based on the delta value for each nutrient. This informs those responsible for farm management as to the current levels of each nutrient in each zone of the field, and therefore the amount of nutrients the soil require for the next season can be determined.

A user may access the soil nutrient information 112 and crop yield information 114 via the end node computer 130, input the period of time the extracted data is to correspond to, and view the generated productivity map.

In some cases, the database 110 storing the soil nutrient information 112 and crop yield information 114 may be stored on the server 120, or on the end node computer 130. In some cases, the data retrieving module 122, calculating or analysing module 124, and reporting module 126 may also be stored on and executed by the end node computer 130.

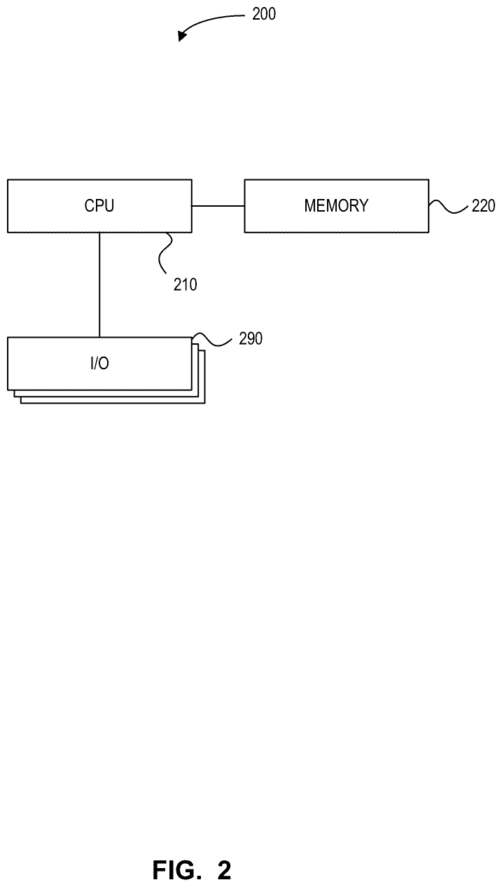

Referring now to FIG. 2, there is illustrated a simplified block diagram of a computer in accordance with at least some embodiments. Computer 200 is a generic example of a computer, such as the server 120 or end node computer 130 of FIG. 1. Computer 200 generally has at least one processor 210 operatively coupled to at least one memory 220, and at least one additional input/output device 290.

The at least one memory 220 includes a volatile memory that stores instructions executed or executable by processor 210, and input and output data used or generated during execution of the instructions. Memory 220 may also include non-volatile memory used to store input and/or output data along with program code containing executable instructions.

Processor 210 may transmit or receive data via a data communications interface (not shown), or may also transmit or receive data via any additional input/output device 290 as appropriate. Examples of I/O devices 290 may include interfaces for farm implements such as a distributor or spreader. Other examples of I/O devices 290 may include a Global Positioning System (GPS) receiver or inertial navigation system (INS).

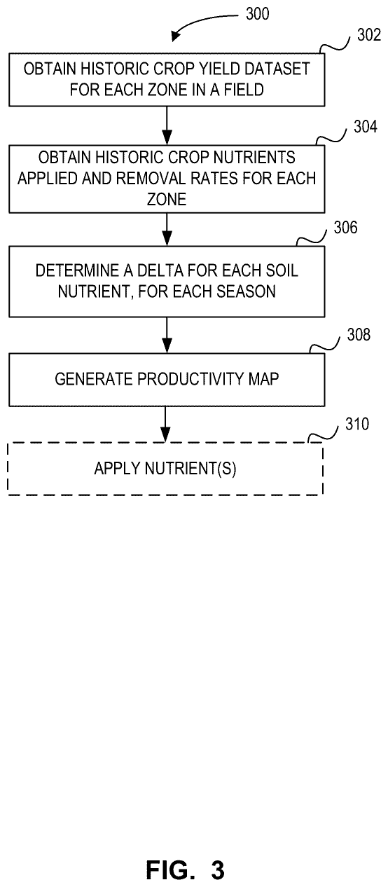

Referring now to FIG. 3 there is illustrated a method 300 for nutrient management in a field. At step 302 the crop yield information 114 is obtained. This may be obtained, for example, by the user extracting it from the database 110 via the computer 130. At step 304 the crop uptake and removal rate information 112, e.g. the crop nutrients applied, is obtained. This may be obtained, for example, by the user extracting it from the database 110 via the computer 130. At step 306 a delta value for each soil nutrient in each zone is determined. A delta value is calculated for every nutrient and for every zone in the field. At step 308 a productivity map 500 is generated by the reporting module 126. Optionally, at step 310, at least one nutrient is applied to the field based on the productivity map. For instance, a computer with GPS or INS capability may control, through an appropriate interface, a distributor (e.g., spreader or other farm implement) to apply the nutrients to the field based on the productivity map. Alternatively, the computer may display the productivity map and/or instructions for applying the nutrients.

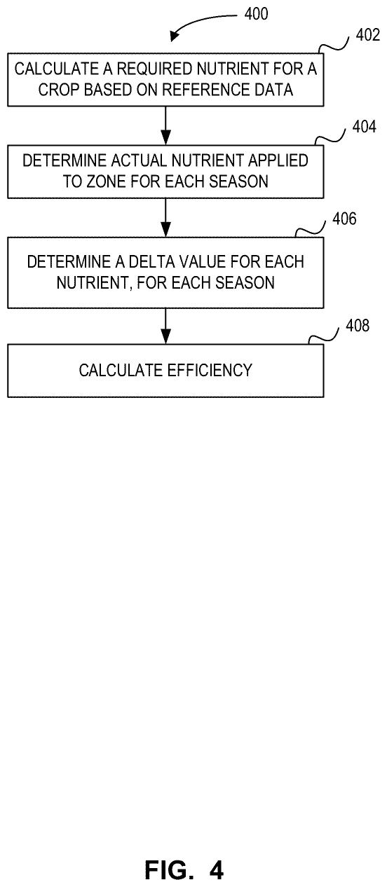

Referring now to FIG. 4 there is illustrated a method 400 for the determining the delta value for soil nutrients, such as in step 306 in the method 300. To calculate the delta value for each nutrient in each zone of the field, first the amount of a nutrient required to grow a crop is determined. This may be based on standard reference data, such as from the “Plant nutrient and soil fertility manual” by J. B. Jones Jr (2012). This is determined at step 402 and is calculated, e.g., for nitrogen, with the equation:

$$Nutrient {Required}_{Nitrogen , Year} = ( {Yield}_{Crop , Year} \times Nutrient {Data}_{Crop , Ref} ) - ( Soil Zone \times ENR )$$

where the yield is for a specific season or year and thus for a specific crop, the nutrient applied is for the specific crop and may be based on known reference data, and the ENR is the estimated nitrogen release based on known reference data. Similar requirements may be calculated for each of phosphorus, potassium, and sulfur with the equation:

$$Nutrient {Required}_{P , K , S , Year} = {Yield}_{P , K , S , Year} \times Nutrient {Data}_{P , K , S , Year}$$

This is calculated for every crop of interest. Generally, it is calculated for every different crop as different crops have different nutrient requirements.

At step 404 the actual amount of nutrient applied to the zone is determined. The amount may be determined based on manual records, by averaging a total amount of nutrient applied to the field in previous seasons, and/or, if available, by obtaining finer-grained data from equipment that can identify the amount applied per unit area of the field (e.g., GPS-connected distributor equipment). This information may be stored as a data set similar to the datasets on soil nutrient information 112 and crop yield information 114 stored in the database 130, or may be stored on a flash drive and manually retrieved or similar.

At step 406 the delta (A) for the nutrient is determined. This is calculated with the equation:

$${Δ}_{Nutrient , Crop} = \frac{Nutrient Actually Applied}{Nutrient {Required}_{Crop , Year}}$$

where the nutrient required is the value previously calculated for the specific crop in the specific year. The nutrient actually applied is the actual amount of nutrient applied to the zone in the field. These calculations are performed for each year, or season, for which there is yield data and actual nutrient application data. Nitrogen is planned for as a crop uptake, whereas phosphorus, potassium, and sulfur are planned for as removal rates. This calculation process results in a delta value for each nutrient, for each year of extracted data 112, 114, and in each zone of the field. An efficiency is then calculated for each nutrient in each zone.

At step 408 the efficiency is calculated as the mean average of the delta values for the nutrient. The efficiency for each nutrient provides an indication as to the level of nutrient in the soil; Table 1 provides examples. An efficiency that is about 1 shows that the amount of nutrient applied to the zone is approximately equal to the amount of nutrient extracted by the crop as it grows, e.g. for phosphorus and sulfur in Table 1. An efficiency that is about 2 shows that there is almost double the amount of nutrient in the soil than required, e.g. for nitrogen in Table 1. An efficiency that is greater than 1 but less than 2 is “building” the soil, meaning that the nutrient is accumulating in the soil, e.g. for potassium in Table 1. An efficiency less than 1 shows that more nutrient is being extracted from the coil by the crop than is being applied.

TABLE 1

| | Δ_{Nitrogen} | Δ_{Phosphorus} | Δ_{Potassium} | Δ_{Sulfur} |
|---|---|---|---|---|
| Year 1 | 1.73 | 0.99 | 0.88 | 0.75 |
| Year 2 | 1.34 | 0.63 | 1.56 | 0.88 |
| Year 3 | 2.45 | 1.42 | 1.35 | 1.15 |
| Efficiency | 1.84 | 1.01 | 1.26 | 0.93 |

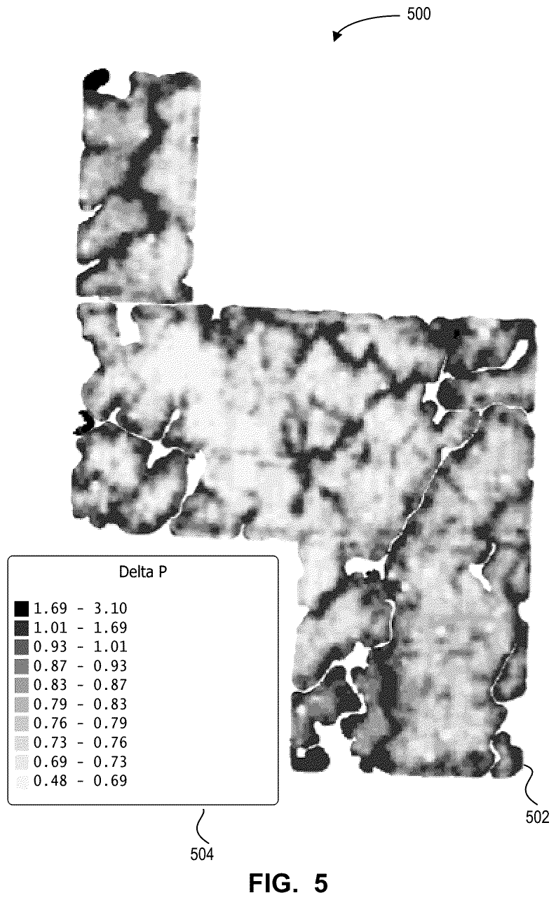

Referring now to FIG. 5 there is illustrated a productivity map 500. The reporting module 126 generates the productivity map 500 based on the calculated delta values and efficiencies. The field has a field boundary 502, inside which the field is then divided into zones. Depending on the efficiency, the zone is allocated a shade on the productivity map 500 which shows whether the soil in the zone has an adequate level of nutrient, whether a nutrient is being accumulated in the soil, or whether a nutrient is being depleted in the soil. The legend 504 for the productivity map 500 illustrates the shade associated with the efficiency.

The described nutrient management system and methods enable those responsible for field management to determine the levels of different soil nutrients in each zone of a field, and to optimize the nutrient application process for each zone to avoid over or under fertilizing the zone, and for the crop being grown in the zone. The optimized nutrient application process improves efficiency and also assists in preserving the soil for further use.

The described nutrient management system and methods generalize precision agriculture approaches for soil sampling which can vary from 30% to orders of magnitude across the field and year to year. The described system and methods provide a model that can at least match soil testing accuracy and removes a barrier of entry for large scale farms to model nutrient efficiency over their entire farm. There are over 140 different factors that can affect crop yield, and by generalizing that all these factors impact the process of how efficiently inputs are converted to outputs, the system and methods make nutrient planning for variable rate technology less intensive and more scalable.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art. Although embodiments have been described above with reference to the accompanying drawings, those of skill in the art will appreciate that variations and modifications may be made without departing from the scope thereof as defined by the appended claims.

We claim:

1. A method for nutrient management for a field, the method comprising:
obtaining a plurality of crop yield datasets for the field, each of the crop yield datasets containing a plurality of point yields corresponding to a plurality of locations in the field and corresponding to a plurality of seasons;
obtaining a plurality of historic crop uptake and removal rates for the field, each of the plurality of historical crop uptake and removal rates corresponding to the plurality of locations in the field;
determining a delta of at least one soil nutrient based on the obtained historic crop yield datasets for each of the plurality of locations in the field and the obtained crop uptake and removal rates; and
generating a productivity map for the field based on the delta of the at least one soil nutrient.

2. The method of claim 1, wherein the at least one soil nutrient is at least one of nitrogen, phosphorous, potassium and sulfur.

3. The method of claim 1, further comprising determining a previously grown crop in each of the plurality of locations in the field.

4. The method of claim 1, further comprising extracting nutrient information from a reference table.

5. The method of claim 1, wherein each of the plurality of historic crop uptake and removal rates is determined based on a corresponding crop yield dataset, a corresponding location in the field, and an amount of nitrogen released.

6. The method of claim 5, wherein the amount of nitrogen released is based on an amount of nitrogen applied in a season of the plurality of seasons and an amount of nitrogen removed by a crop, the amount of nitrogen removed by the crop extracted from the reference table.

7. The method of claim 1, wherein the determining the delta of the at least one soil nutrient further comprises dividing each of the plurality of crop uptake and removal rates by the nutrient information extracted from the reference table.

8. The method of claim 7, further comprising determining an average efficiency for the at least one soil nutrient based on the delta for the at least one soil nutrient for the plurality of seasons.

9. The method of claim 1, wherein the plurality of locations in the field is determined based on a grid, point, or polygon pattern, and wherein the grid and point pattern are based on latitude and longitude.

10. The method of claim 1, further comprising providing a recommendation of an amount of the at least one soil nutrient to apply to each of the plurality of locations in the field.

11. The method of claim 1, further comprising applying the at least one soil nutrient based on the productivity map.

12. The method of claim 11, wherein the applying comprises controlling a distributor to apply the at least one soil nutrient.

13. A system for nutrient management for a field, the system comprising:
a memory storing at least one seasonal yield dataset for the field, containing a plurality of point yields corresponding to a plurality of locations in the field; and
a processor, the processor configured to:
obtain a plurality of crop yield datasets for the field, each of the crop yield datasets containing a plurality of point yields corresponding to a plurality of locations in the field and corresponding to a plurality of seasons;
obtain a plurality of historic crop uptake and removal rates for the field, each of the plurality of historical crop uptake and removal rates corresponding to the plurality of locations in the field;
determine a delta of at least one soil nutrient based on the obtained historic crop yield datasets for each of the plurality of locations in the field and the obtained crop uptake and removal rates; and
generate a productivity map for the field based on the delta of the at least one soil nutrient.

14. A non-transitory computer readable medium storing instructions executable by a computer processor, the instructions when executed by the computer processor cause the computer processor to carry out a method of nutrient management for a field, the method comprising:
obtaining a plurality of crop yield datasets for the field, each of the crop yield datasets containing a plurality of point yields corresponding to a plurality of locations in the field and corresponding to a plurality of seasons;
obtaining a plurality of historic crop uptake and removal rates for the field, each of the plurality of historical crop uptake and removal rates corresponding to the plurality of locations in the field;
determining a delta of at least one soil nutrient based on the obtained historic crop yield datasets for each of the plurality of locations in the field and the obtained crop uptake and removal rates; and
generating a productivity map for the field based on the delta of the at least one soil nutrient.
